(19) United States
(12) Patent Application Publication
(10) Pub. No.: US 2004/0104676 A1
(43) Pub. Date: Jun. 3, 2004

(54) Gas discharge panel

(76) Inventors: Ga-Lane Chen, Fremont, CA (US); Charles Leu, Fremont, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/662,031

(22) Filed: Sep. 12, 2003

(30) Foreign Application Priority Data
Nov. 29, 2002 (TW) 91134738

(51) Int. Cl. H01J 17/49

(52) U.S. Cl. 313/582

(57) ABSTRACT

A gas discharge display for emitting light by discharging a discharge gas confined in a discharge space (25) utilizes electrodes (12, 12′, 22) to produce ultraviolet light and utilizes the ultraviolet light to irradiate a phosphor layer (23) to produce visible light. The discharge gas is a gas mixture including neon and krypton, where a proportion of the krypton is 1.1 to 5% by volume of the gas. A pressure of the gas is kept within a range of 250 Torr to 500 Torr.

### BACKGROUND OF THE INVENTION

1. Field of the Invention

The present invention relates to a gas discharge display and more particularly, to a gas discharge display for use in a plasma display panel (PDP).

2. The Related Arts

Recently, as expectations for high-quality and large-screen TVs, such as high-definition TVs, have increased, displays suitable for such TVs, such as CRTs, Liquid Crystal Displays (LCD), and Plasma Display Panels (PDP), have been developed.

CRTs have been widely used as TV displays and excel in resolution and picture quality. However, their depth and weight increase as a screen size increases. Therefore, CRTs are not suitable for screens larger than 40-inches in size. LCDs have high performance with low power consumption and low driving voltage. However, producing a large LCD is technically difficult and the viewing angles of LCDs are limited.

On the other hand, it is possible to produce a large-screen PDP having a short depth, and 50-inch PDP products have already been developed.

PDPs are broadly divided into two types: direct current type (DC type) and alternating current type (AC type). Currently, PDPs are mainly AC type.

An ordinary AC PDP includes a front cover plate, a back plate, and partition walls called barrier ribs inserted between the front cover plate and the back plate to form discharge spaces. Discharge gas is charged into the discharge spaces. The front cover plate with display electrodes thereon is covered with a dielectric glass layer made of lead glass. The back plate is provided with address electrodes, the barrier ribs, and phosphor patches made of red, green, or blue ultraviolet excitation phosphors, one pitch of one color per discharge space.

The light-emission principle of PDPs is basically the same as that of fluorescent lights. That is, in PDPs, voltage is applied to electrodes to generate glow discharges, ultraviolet light is emitted from the discharge gas by the glow discharges, the ultraviolet light excites the red, green or blue ultraviolet excitation phosphors, and the phosphors emit visible rays.

The discharge gas is ordinarily a helium(He)-xenon(Xe) or a neon(Ne)-xenon(Xe) gas mixture, and in this case the content of Xe is about 1-5% by volume. When the gas mixture as above is used, the reaction of Xe prevails at the time of discharges, and vacuum ultraviolet rays of wavelengths from about 147 to 200 nm are emitted. Accordingly, the prior art plasma display devices are provided with fluorescent materials, which can be excited by the ultraviolet rays whose wavelengths are from about 147 to 200 nm.

However, when a mixture of Ne—Xe, or He—Xe is employed as a discharge gas, in addition to the ultraviolet rays, intense near infrared rays whose wavelengths are from about 800 to 1,000 nm are emitted from Xe, and such near infrared rays may adversely affect the operation of other nearby appliances, such as infrared remote controllers used for TVs, etc. Furthermore, a color purity of displayed images is decreased. Therefore, the PDP must be provided with a filter for shielding the near infrared rays. Such a filter is known to not only increase the production cost but also to decrease the luminance of an image by at least 30%.

Referring to U.S. Pat. No. 6,285,129, a plasma display device employs a discharge gas of pure He or a gas mixture of more than 99.5 vol % He, with the balance being of at least one gas selected from the group consisting of Ne, Ar, Kr and Xe. However, although the use of He can improve the light emitting efficiency as well as the color purity, the increased use of He accelerates sputtering of the fluorescent materials and the protection layer, resulting in a short operational life of the PDP, because He has a smaller collision cross-section.

An improved gas discharge display for use in a PDP, which overcomes the above-mentioned disadvantages, is desired.

### SUMMARY OF THE INVENTION

An object of the present invention is to provide an improved gas discharge display for use in a plasma display panel (PDP), which employs a gas mixture of Neon and a rare earth gas as a discharge gas to improve color purity and to enhance operational life of the PDP.

A gas discharge display for emitting light by discharging a discharge gas occupying a discharge space (25) utilizes electrodes (12, 12′, 22) to produce ultraviolet light and utilizes the ultraviolet light emitted into a phosphor layer (23) to produce visible light. The discharge gas is a gas mixture including neon and krypton, a proportion of the krypton being 1.1 to 5% by volume. A pressure of the gas is set in a range of 250 Torr to 500 Torr.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of an AC plasma display panel according to the present invention; and

FIG. 2 is a cross-sectional view of the AC plasma display panel of FIG. 1, when assembled.

### DETAILED DESCRIPTION OF THE PREFERRED EMBODIMENT

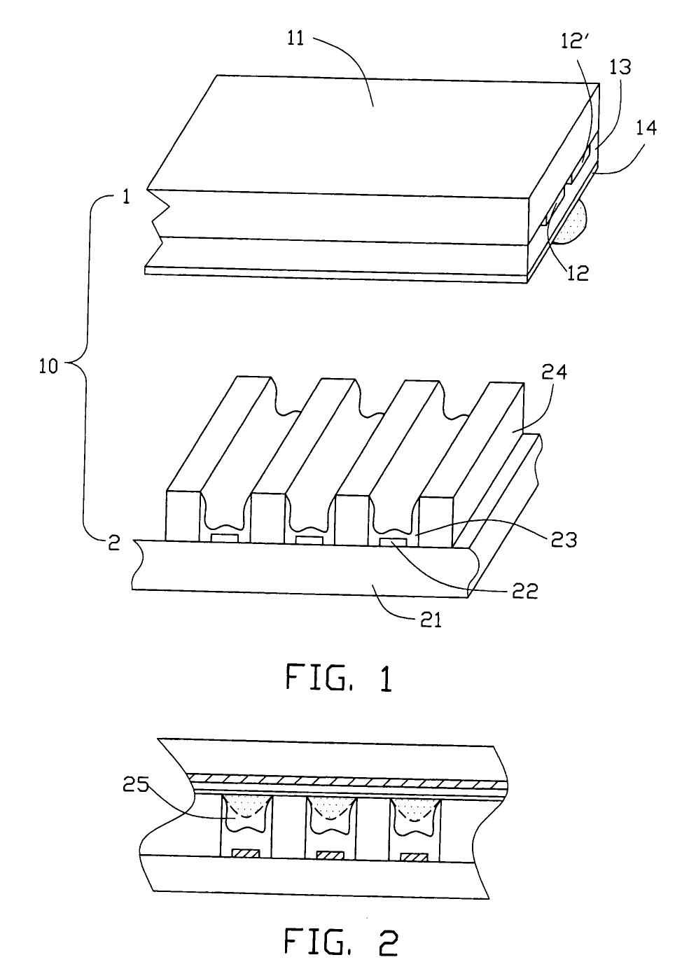

As shown in FIG. 1, an exploded perspective view of an AC plasma display panel (PDP) 10 of the present invention includes a first panel 1 and a second panel 2. The first panel 1 has a front glass substrate 11 with display electrodes 12 and 12′, a dielectric layer 13, and a protecting layer 14. The second panel 2 has a back glass substrate 21 with address electrodes 22. The first panel 1 and the second panel 2 are placed in parallel so that the display electrodes 12, 12′ oppose the address electrodes 22 with a predetermined distance therebetween. A space between the first panel 1 and the second panel 2 is partitioned by strip-like barrier ribs 24 to form discharge spaces 25 between the barrier ribs 24, the back glass substrate 21 and the protecting layer 14. The discharge spaces 25 are filled with a discharge gas.

The second panel 2 further is provided with phosphor patches 23. Red, green, and blue phosphor patches are applied, one phosphor patch having one color, per corresponding discharge space 25, in a repeating order of colors throughout the PDP 10.

The display electrodes 12, 12′ are strip-like silver electrodes and are arranged perpendicular to the barrier ribs 24. The address electrodes 22 are arranged parallel to the barrier ribs 24.

Cells that respectively emit red, green or blue rays are formed at the intersections of the display electrodes 12, 12′ and the address electrodes 22.

The dielectric layer 13 is 20 micrometers in thickness and is made of lead glass or another glass material. The entire surface of the front glass substrate 11 with the display electrodes 12, 12′ thereon is covered with the dielectric layer 13.

The protective layer 14 is a thin layer made of magnesium oxide (MgO) and covers an entire surface of the dielectric layer 13.

The barrier ribs 24 are arranged to protrude from a surface of the back glass substrate 21.

The PDP 10 is driven using a driving circuit as follows. Firstly, addressing discharge is performed by applying a voltage between the display electrodes 12 and the address electrodes 22 of the cells to be illuminated. Then, sustaining discharge is performed by applying a pulse voltage between the display electrodes 12 and the display electrodes 12′ of the cells to emit ultraviolet light. Finally, the ultraviolet light irradiates the phosphor patches 23 and the phosphor patches 23 emit visible rays to illuminate the cells.

The discharge gas, peculiar to the present invention, is a mixture of neon and krypton gases. Here, it is preferable that the proportion of krypton is set to 1.1%-5% by volume. Since the metastable level of krypton is 16.7 ev, and this is larger than the ionization energy, 8.34 ev, of neon, the discharge gases are ionized as follows, utilizing the Penning Effect,

Ne*+Kr→Ne+Kr*+e

where Ne is a major gas, Kr is an additive gas, and Ne* and Kr*are metastable or exited states of pertinent gases. Thus, when a voltage is applied, the discharge gas will be excited to emit ultraviolet light.

The setting of the composition of the discharge gases is related to color purity and operational life of the PDP 10. As the krypton content is increased, the flux of unnecessary visible light spectrum (580 nm) photons emitted by the neon gas is decreased, so that the flux of ultraviolet photons, which excite the fluorescent material, is increased relative to the 580 nm photon flux. The result is an enhancement in the purity of the color displayed. When the Kr component is more than approximately 1%, the color purity is improved by more than 30%. On the other hand, a firing voltage of the PDP 10 increases with the proportion of the Kr component in the discharge gas, which can improve the light utilization efficiency and the illumination intensity of the PDP 10. However, with the increase in firing voltage comes an instability of the current. Therefore, there is a higher probability that the discharge state will shift to an arc discharge. Once the discharge state is shifted to an arc discharge, heat is produced, causing thermal ionization in the discharge gases. Accordingly, it is desirable to prevent a shift in the discharge state to an arc discharge. So, in order to suppress the firing voltage and achieve a stable display, the krypton density has to be less than 5%. In other words, the krypton density range to accomplish the object of the present invention is 1.1 to 5% by volume.

In addition, a total pressure of the discharge gases is desired to be between about 100 Torr and about 500 Torr. If the pressure is lower than 100 Torr, the light emission efficiency is lowered and the firing voltage must increase. On the other hand, if the pressure is higher than 760 Torr, the discharge panel may be deformed. Furthermore, as the gas pressure increases, the proportion of ultraviolet light emitted at 173 nm increases. When the gas pressure is set to 500 Torr, the proportion of ultraviolet light emitted at 173 nm becomes larger than that emitted at 147 nm. As described above, as the wavelength of ultraviolet emission becomes longer, (1) the amount of ultraviolet light emitted increases and (2) the conversion efficiency of fluorescent materials is improved.

Furthermore, since krypton has a larger collision cross-section than neon, a larger proportion of krypton gas can suppress sputtering. Thus, krypton gas can contribute to the suppression of the near-infrared radiation and enhance the operational life of the panel 10.

Although the above description of the preferred embodiment is for an AC-type surface discharge PDP 10, it is apparent that the present invention can be applied to a DC-type surface discharge PDP, and an AC or DC-type opposing discharge PDP. Furthermore, the present invention can be applied to a plasma addressed liquid crystal, usually referred to as a PALC.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A gas discharge display for emitting light by discharging a discharge gas confined in a discharge space using electrodes to produce ultraviolet light and utilizing the ultraviolet light to irradiate a phosphor layer, thereby producing a visible ray, comprising:
a gas mixture as the discharge gas, which includes neon and krypton.

2. The gas discharge display of claim 1, wherein a proportion of the krypton is 1.1% to 5% by volume in the gas mixture.

3. The gas discharge display of claim 1, wherein a pressure of the gas is in a range of 250 Torr to 500 Torr.

4. The gas discharge display of claim 1, wherein the gas discharge display further comprises a front and a back glass substrate, and the electrodes are arranged on the front and the back glass substrates, respectively.

5. The gas discharge display of claim 4, wherein the front glass substrate with the electrodes are covered by a dielectric layer thereon.

6. The gas discharge display of claim 5, wherein a protective layer covers the entire surface of the dielectric layer.

7. The gas discharge display of claim 6, wherein the protective layer is made of magnesium oxide (MgO).

8. A gas discharge display for emitting light, comprising:
a plurality of discharge spaces formed by a space between a front glass substrate and a back glass substrate partitioned by a plurality of barrier ribs;
a plurality of electrodes arranged on the front glass substrate and the back glass substrate, respectively;
a plurality of phosphor patches applied on the back glass substrate, per corresponding a discharge space; and
a discharge gas confined in the discharge space having neon and krypton;
wherein the gas discharge display emit light by using the electrodes applying a voltage to the discharge gas to produce ultraviolet light and utilizing the ultraviolet light to irradiate the phosphor patch, thereby producing a visible ray.

9. The gas discharge display of claim 8, wherein a proportion of the krypton is 1.1% to 5% by volume in the discharge gas.

10. The gas discharge display of claim 8, wherein a pressure of the discharge gas is in a range of 250 Torr to 500 Torr.

11. The gas discharge display of claim 8, wherein the front glass substrate with the electrodes are covered by a dielectric layer thereon.

12. The gas discharge display of claim 11, wherein a protective layer covers the entire surface of the dielectric layer.

13. The gas discharge display of claim 12, wherein the protective layer is made of magnesium oxide (MgO).

14. A gas discharge display including means for emitting light by discharging a discharge gas confined in a discharge space and using electrodes to produce ultraviolet light and utilizing the ultraviolet light to irradiate a fluorescent layer, thereby producing a visible ray, wherein
the discharge gas is a gas mixture which includes neon and krypton.

15. The gas discharge display of claim 14, wherein a proportion of the krypton is 1.1% to 5% by volume in the gas mixture.

16. The gas discharge display of claim 14, wherein a pressure of the gas is in a range of 250 Torr to 500 Torr.

17. The gas discharge display of claim 14, wherein the gas discharge display further comprises a front and a back glass substrate, and the electrodes are arranged on the front and the back glass substrates, respectively.

18. The gas discharge display of claim 17, wherein the front glass substrate with the electrodes are covered by a dielectric layer thereon.

19. The gas discharge display of claim 18, wherein a protective layer covers the entire surface of the dielectric layer.

20. The gas discharge display of claim 19, wherein the protective layer is made of magnesium oxide (MgO).
